(19) United States
(12) Patent Application Publication
(10) Pub. No.: US 2020/0062198 A1
(43) Pub. Date: Feb. 27, 2020

(54) WIRE HARNESS FIXING STRUCTURE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Masaki MIZUSHITA, Mie (JP); Kenta ITO, Mie (JP); Yuichi NAKAMURA, Mie (JP); Susumu HIEI, Mie (JP); Kohei YAMAGUCHI, Mie (JP); Daisuke FUKAI, Mie (JP); Haruka NAKANO, Mie (JP); Motohiro YOKOI, Mie (JP); Housei MIZUNO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/609,322

(22) PCT Filed: May 2, 2018
(86) PCT No.: PCT/JP2018/017486

§ 371 Date: Oct. 29, 2019

(30) Foreign Application Priority Data
May 12, 2017 (JP) 2017-095542

(51) Int. Cl. B60R 16/02; H02G 3/32; H02G 3/00; H02G 3/34

(52) U.S. Cl. CPC B60R 16/0215; H02G 3/34; H02G 3/266; H02G 3/32

(57) ABSTRACT

A wire harness fixing structure includes an interior member including a plate-like member and interiorly mounted on a vehicle and a wire harness including an electrical wire disposed along the plate-like member and a sheet material to which the electrical wire is fixed by sewing or welding. The wire harness is fixed to the interior member while the sheet material is spread.

### TECHNICAL FIELD

The present invention relates to a technique of fixing a wire harness to a mounting object.

### BACKGROUND ART

A technique of fixing a wire harness to a mounting object is described in Patent Documents 1 and 2, for example. Patent Document 1 discloses a technique of fixing a wire harness to a mounting object using a clamp (also referred to as a clip, for example). Patent Document 2 discloses a technique of fixing a roof harness to a roof lining (also referred to as a head lining or a roof trim, for example).

Herein, when the wire harness is fixed using the clamp as is the case for Patent Document 1, a hole for fixing the clamp needs to be formed in the mounting object. However, when the mounting object of the wire harness is a member exposed indoors such as the roof lining described in Patent Document 2, there is a possibility that the clamp may be exposed indoors in a case where a hole for fixing the clamp is formed in the member and the clamp is inserted into and locked to the hole. As described above, it may not be appropriate in some cases, depending on the mounting object, to apply the technique of forming the hole for fixing the clamp and fixing the clamp.

Thus, in Patent Document 2, the roof harness is fixed to the roof lining by an adhesive agent such as a one-sided adhesive tape or a hot-melt material.

### PRIOR ART DOCUMENTS

### Patent Documents

Patent Document 1: Japanese Patent Application Laid-Open No. 2000-335329

Patent Document 1: Japanese Patent Application Laid-Open No. 2012-10474

### SUMMARY

### Problem to be Solved by the Invention

Since the roof harness has a small area of contact with the roof lining, it is hard to fix the roof harness using a member such as a double-sided adhesive tape in which an adhesive force per unit of area is not relatively large and an adhesion area cannot be made large. That is to say, the hot-melt adhesive agent or the double-sided tape is used for fixing the roof harness to the roof lining as described above by reason that such a member has characteristics that the adhesive force per unit of area is relatively large or the adhesion area can be made large.

However, there is a possibility that the number of manufacturing processes in assembling a vehicle increases in a fixing method using the adhesive agent such as the one-sided adhesive tape or the hot-melt material.

An object of the present invention is to provide a technique capable of simply fixing a wire harness in assembling a vehicle even to a mounting object which is not suitable for having a clamp hole to fix a clamp.

### Means to Solve the Problem

In order to solve the above problem, a wire harness fixing structure according to a first aspect includes an interior member including a plate-like member and interiorly mounted on a vehicle and a wire harness including an electrical wire disposed along the plate-like member and a sheet material to which the electrical wire is fixed by sewing or welding, wherein the wire harness is fixed to the interior member while the sheet material is spread.

The wire harness fixing structure according to a second aspect is the wire harness fixing structure according to the first aspect, further including a pressure sensitive adhesive double sided tape intervening between the sheet material and the interior member.

The wire harness fixing structure according to a third aspect is the wire harness fixing structure according to the first or second aspect, further including a touch fastener intervening between the sheet material and the interior member.

The wire harness fixing structure according to a fourth aspect is the wire harness fixing structure according to the third aspect, wherein the touch fastener includes a male member fixed to the sheet material and having hooks protruding toward the plate-like member, and a surface layer in the plate-like member is formed of a material having characteristics that the hooks can be hooked.

The wire harness fixing structure according to a fifth aspect is the wire harness fixing structure according to any one of the first to fourth aspects, wherein the interior member includes an attaching member incorporated into the plate-like member and crossing the electrical wire, and the sheet material is sandwiched between the plate-like member and the attaching member together with the electrical wire, thus the wire harness is fixed to the interior member.

The wire harness fixing structure according to a sixth aspect is the wire harness fixing structure according to the fifth aspect, wherein a groove in which the electrical wire is housed is formed on at least one of the plate-like member and the attaching member in a portion where the electrical wire is sandwiched.

The wire harness fixing structure according to a seventh aspect is the wire harness fixing structure according to any one of the first to sixth aspects, wherein the sheet material extends along a path of the electrical wire.

### Effects of the Invention

According to the first to seventh aspects, a contact area between the wire harness and the interior member can be increased, thus even when a force for the fixation per unit area is small, the wire harness can be fixed to the interior member. Thus, the wire harness can be fixed to the interior member also by previously providing a fixing member on the wire harness. Accordingly, the wire harness can be simply fixed, in assembling the vehicle, even to a mounting object which is not suitable for having a clamp hole to fix a clamp.

Particularly, according to the second aspect, the wire harness can be simply fixed by using the pressure sensitive adhesive double sided tape.

Particularly, according to the third aspect, the wire harness can be simply fixed by using the touch fastener.

Particularly, according to the fourth aspect, the wire harness can be fixed to the plate-like member by using the male member provided on the wire harness. At this time, the surface layer in the plate-like member is formed of the material having the characteristics that the hooks can be hooked, thus the male member can be fastened on any position in the plate-like member.

Particularly, according to the fifth aspect, the wire harness can be simply fixed by using the plate-like member and the attaching member.

Particularly, according to the sixth aspect, it can be suppressed that the electrical wire is sandwiched with the large force.

Particularly, according to the seventh aspect, the area of the sheet material can be reduced, thus the increase in weight caused by providing the sheet material can be reduced.

### BRIEF DESCRIPTION OF DRAWINGS

FIG. 1 A schematic exploded perspective view illustrating a wire harness fixing structure according to an embodiment and an assembling object thereof.

FIG. 2 A schematic plan view illustrating the wire harness fixing structure according to the embodiment.

FIG. 3 A cross-sectional view of the wire harness fixing structure cut along a III-III line in FIG. 2.

FIG. 4 A cross-sectional view of the wire harness fixing structure cut along a IV-IV line in FIG. 2.

FIG. 5 A schematic perspective view illustrating a wire harness according to the embodiment.

FIG. 6 A schematic plan view illustrating the wire harness according to the embodiment.

FIG. 7 A schematic perspective view illustrating a modification example of the wire harness.

FIG. 8 A schematic cross-sectional view illustrating a first modification example of the wire harness fixing structure.

FIG. 9 A schematic cross-sectional view illustrating a second modification example of the wire harness fixing structure.

FIG. 10 A schematic cross-sectional view illustrating a third modification example of the wire harness fixing structure.

### DESCRIPTION OF EMBODIMENT(S)

### Embodiment

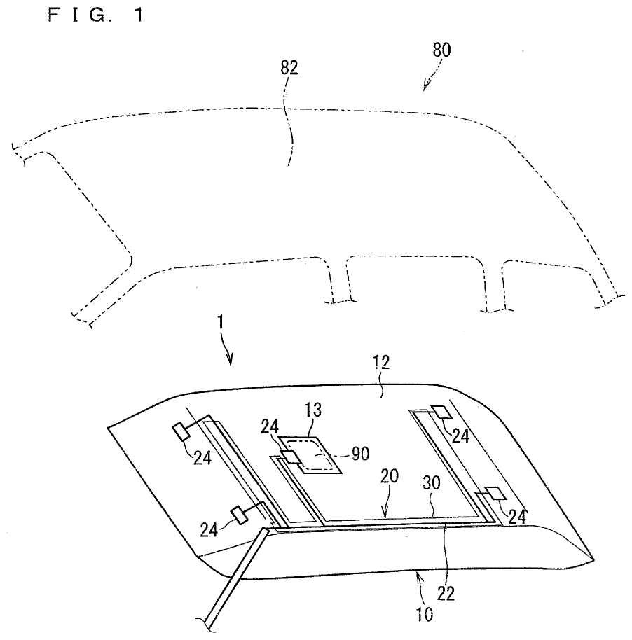

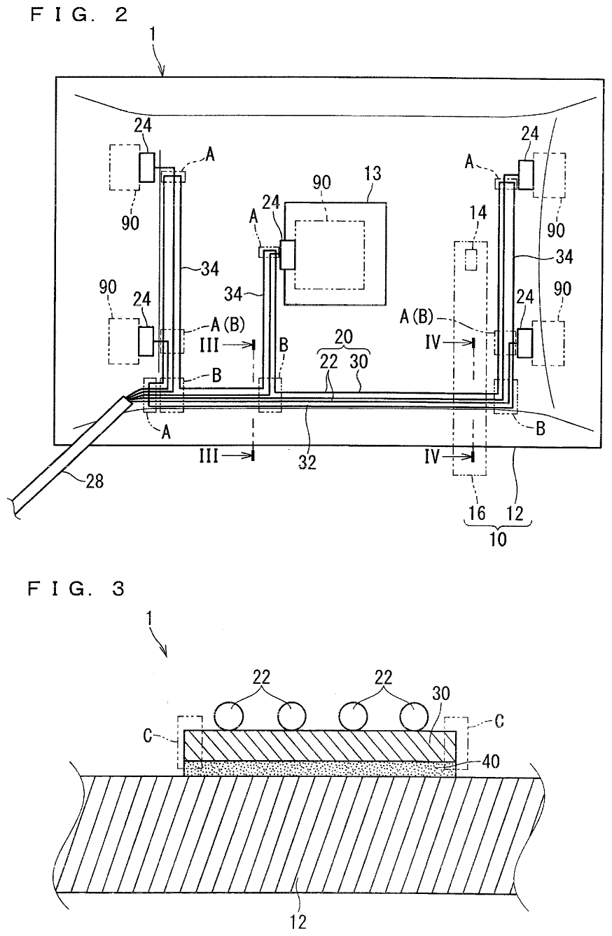

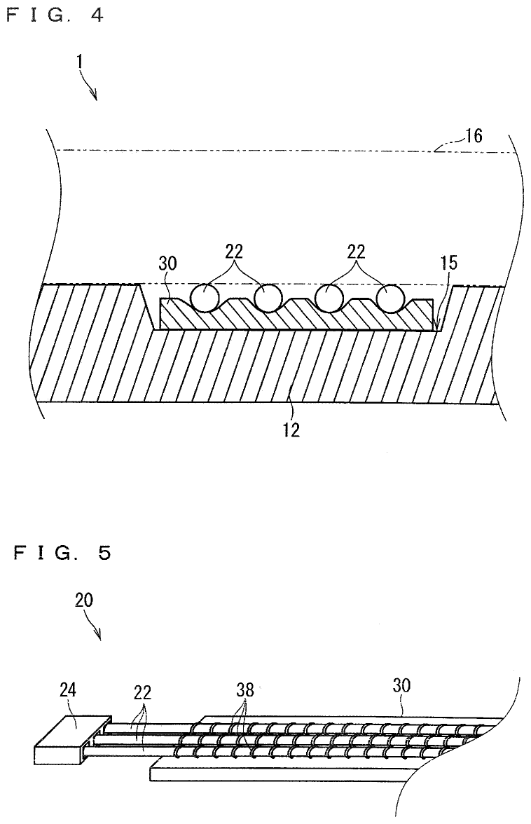

A wire harness fixing structure according to an embodiment is described hereinafter. FIG. 1 is a schematic exploded perspective view illustrating a wire harness fixing structure 1 according to the embodiment and an assembling object thereof. FIG. 2 is a schematic plan view illustrating the wire harness fixing structure 1 according to the embodiment. FIG. 3 is a cross-sectional view of the wire harness fixing structure 1 cut along a III-III line in FIG. 2. FIG. 4 is a cross-sectional view of the wire harness fixing structure 1 cut along a IV-IV line in FIG. 2.

The wire harness fixing structure 1 according to the embodiment includes an interior member 10 and a wire harness 20 fixed to the interior member 10.

The interior member 10 is a member interiorly mounted on a vehicle. Specifically, the interior member 10 includes a plate-like member 12. Herein, the interior member 10 further includes an attaching member 16 incorporated into the plate-like member 12.

More specifically, the plate-like member 12 is described as a roof lining herein. Accordingly, the plate-like member 12 is attached to an inner surface of a ceiling part 82 in a vehicle body 80. However, it is also considered that the plate-like member 12 is a member interiorly mounted on the other part, such as a door trim, in a vehicle. At this time, the wire harness fixing structure 1 is preferable in a case where one surface of the plate-like member 12 is exposed indoors.

Known as such a roof lining is a roof lining including a foam resin layer for purpose of sound absorption or thermal insulation and a reinforcement layer provided on both surfaces of the foam resin layer to reinforce the foam resin layer. Considered as a configuration of the reinforcement layer is that a plate material provided separately from the foam resin layer is joined to a plate material constituting the foam resin layer. Considered in this case as the plate material constituting the reinforcement layer is, for example, a resin plate material, a plate material made of glass fiber, carbon fiber, basalt fiber, natural fiber, and organic fiber, or a non-woven cloth.

When the plate-like member 12 is the roof lining, considered is that a surface skin layer is stacked on an outer surface of the reinforcement layer. The surface skin layer is formed of a material such as a non-woven cloth, a woven cloth, or a knitted cloth, for example. A surface of the plate-like member 12 on a side of the vehicle body 80 is referred to as a rear surface in some cases hereinafter.

The attaching member 16 is disposed on the rear surface of the plate-like member 12. The attaching member 16 is incorporated into the plate-like member 12 and crossing electrical wires 22. A duct for an air conditioner, for example, is considered as the attaching member 16. This duct is considered a molded component formed by blow molding or injection molding, for example, using a synthetic resin, particularly a foam resin, for example. The duct is fixed to the plate-like member 12 by an adhesive agent such as a hot-melt material, for example. The duct includes a part extending outside the roof lining, for example. The part of the duct extending outside the roof lining extends to a lower side of the vehicle body 80 along a pillar, for example, and is connected to an air conditioner incorporated into the vehicle. Air supplied inside the duct is blown indoors through an outlet 14 formed in the roof lining.

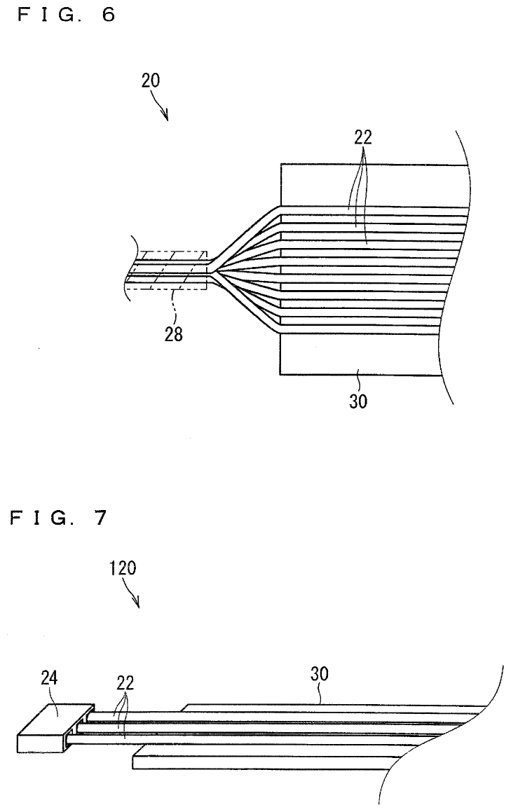

FIG. 5 is a schematic perspective view illustrating the wire harness 20 according to the embodiment. FIG. 6 is a schematic plan view illustrating the wire harness 20 according to the embodiment. FIG. 6 is a drawing illustrating the wire harness 20 in a position different from that in FIG. 5.

The wire harness 20 is disposed on the rear surface of the plate-like member 12. The wire harness 20 includes the electrical wires 22 and a sheet material 30. The electrical wires 22 are fixed to the sheet material 30. Described herein is that the electrical wires 22 are sewn to the sheet material 30 with a thread 38, thereby being fixed to the sheet material 30.

The electrical wires 22 are disposed along the plate-like member 12. More specifically, the electric wires 22 are disposed to have an overlap with the plate-like member 12 in at least a part of a region along a longitudinal direction. Herein, the electrical wires 22 are disposed to have the overlap with the plate-like member 12 in a region including an end portion of the electrical wires 22 in the longitudinal direction. Described herein is that insulated electrical wires each including a core wire and an insulating covering for covering the core wire are applied as the electrical wires 22. The core wire is made of a conductive material such as copper or aluminum. The core wire may be a single wire or a twisted wire. The insulating covering may be formed by extrusion molding, for example, a resin around the core wire or by applying, for example, varnish around the core wire and baking the varnish. However, bare core wires may be adopted as the electrical wires 22.

The number of the electrical wires 22 may be at least one. Herein, the plurality of electrical wires 22 are included. The plurality of electrical wires 22 are disposed in a flat state on the plate-like member 12. In the example described in the present embodiment, the plurality of electrical wires 22 extend from the outside of the plate-like member 12 toward the plate-like member 12 in a bundled form. Then, the plurality of electrical wires 22 are fixed to the sheet material 30, a state of the electrical wires 22 being changed from a bundled state to a flat state on the plate-like member 12 or before the plate-like member 12. The bundled part of the plurality of the electrical wires 22 may be banded by a banding member 28. A pressure sensitive adhesive single sided tape or a banding band, for example, can be used as the banding member 28.

At this time, the plurality of electrical wires 22 are halfway branched on the plate-like member 12, and each of the branched electrical wires 22 extends toward a plurality of connection parts in the plate-like member 12. At this time, the plurality of electrical wires 22 extend while having a common path as long as possible. The sheet material 30 to which the electrical wires 22 is fixed can be thereby used in common. At this time, the electrical wires 22 are disposed on the plate-like member 12 so that an angle formed between two directions in a bent portion of the electrical wires 22 is as close to right angle as possible. However, the path of the electrical wires 22 is not limited thereto described above. Also considered, for example, is that the plurality of electrical wires 22 are branched in a position close to a rim of the plate-like member 12, and each of the branched electrical wires 12 is disposed to extend through a path as short as possible to a position of a destination member 90, which is the other party of connection, while avoiding portions inappropriate for the arrangement of the electrical wires 22 such as an opening 13 and the outlet 14. In this case, the part of the electrical wires 22 past the bundled part may be disposed in a straight line form toward the destination member 90. The electrical wires 22 may be disposed on different sheet materials 30 for each group connected to the common destination member 90.

In the example illustrated in FIG. 2, all terminal portions of the electrical wires 22 are connected to the destination members 90 on the plate-like member 12, however, some of the electrical wires may pass through the plate-like member 12 and extend to a rear side of the vehicle. The destination member 90 is considered an illumination member, a sensor, and an antenna, for example.

The sheet material 30 is a member to which the electrical wires 22 are fixed. The sheet material 30 needs only characteristics that the electrical wires 22 can be fixed on the sheet material 30, thus a material and a manufacturing method thereof are not particularly limited. For example, the sheet material 30 may be made of a synthetic resin, metal, a natural fibrous material such as wool or cotton, or a combination of them. The sheet material 30 is considered a non-woven cloth, a woven cloth, or a knitted cloth, for example. When the sheet material 30 is made of a synthetic resin, for example, the sheet material 30 is considered a material formed by extrusion molding with uniform cross sections. When the sheet material 30 is made of metal, for example, the sheet material 30 is considered a material formed into a foil by rolling.

In the example illustrated in FIG. 2, the sheet material 30 extends along the path of the electrical wires 22. At this time, the sheet material 30 includes a first part 32 and second parts 34. The first part 32 is a part extending in a horizontal direction in FIG. 2. The first part 32 is a part to which a main-line part of the plurality of electrical wires 22 is fixed. The second parts 34 are parts extending in a vertical direction in FIG. 2. The second parts 34 are parts to which branch-line parts of the plurality of electrical wires 22 is fixed. Each of the second parts 34 extends to a position close to a terminal portion of each of the branch-line parts. For example, one piece of the sheet material 30 may be provided to cover the first part 32 and the second parts 34. For example, in each sheet material 30, the first part 32 and the second parts 34 may be made separately. That is to say, the sheet material 30 is preferably formed into a shape corresponding to an arrangement form of the electrical wires 22.

However, the sheet material 30 may be formed into a rectangular shape corresponding to the shape of the plate-like member 12 to cover substantially the whole surface of the plate-like member 12. In this case, the same type of the sheet material 30 can be applied to the electrical wires 22 having different paths depending on a type or grade of a vehicle.

It is also considered that the sheet material 30 has other uses in addition to the fixation of the electrical wires 22 and the support of the electrical wires 22 on the plate-like member 12. Considered as the other uses are, for example, protection, heat radiation, soundproofing, and a tension member.

In the example illustrated in FIG. 2, all of the plurality of electrical wires 22, the state of which is changed from the bundled state to the flat state, are fixed to the sheet material 30. However, when the wire harness 20 includes the plurality of electrical wires 22, the wire harness 20 may include the electrical wires 22 which are not fixed to the sheet material 30.

In the example illustrated in FIG. 2, a branch is formed in the plurality of electrical wires 22 on the sheet material 30. In this case, the plurality of electrical wires 22 may be disposed so that the electrical wires 22 cross the other electrical wires 22 in the branch position on the sheet material 30.

In the example illustrated in FIG. 5, the electrical wires 22 are disposed close to a center of the sheet material 30 in a width direction. However, the position of the electrical wires 22 on the sheet material 30 is not limited thereto described above. The electrical wires 22 may be disposed, for example, close to an end of the sheet material 30 in the width direction. The electrical wires 22 may, for example, extend diagonally to the sheet material 30.

Ends of the electrical wires 22 are incorporated into connectors 24. While the wire harness 20 is disposed in an arrangement target portion in a vehicle, etc., the connectors 24 are connected to the connectors 24 of the various electrical devices mounted on the vehicle, for example. Consequently, the wire harness 20 is used as the wiring for electrically connecting the various electrical devices mounted on the vehicle, for example.

The connectors 24 may be or may not be fixed to the sheet material 30. When the connector 24 is not fixed to the sheet material 30, as illustrated in FIG. 5, there may be a case where a part of the connector 24 has an overlap with a rim of the sheet material 30 but the connector 24 is not fixed to the sheet material 30 as well as a case where the connector 24 is provided on the end of the electrical wires 22 extending from the sheet material 30, thereby not being fixed to the sheet material 30.

In the example illustrated in FIG. 5, the electrical wires 22 are disposed on one main surface of the sheet material 30. A main surface of the sheet material 30 where the electrical wires 22 are not disposed faces the plate-like member 12. However, the main surface of the sheet material 30 where the electrical wires 22 are disposed may face the plate-like member 12. In this case, the electrical wires 22 are sandwiched between the sheet material 30 and the plate-like member 12. The electrical wires 22 may be disposed to halfway transfer from one main surface to the other main surface of the sheet material 30.

Applicable as a method of sewing the electrical wires 22 to the sheet material 30 with the thread 38 is a sewing using a sewing machine or a sewing by hand obviously. When the electrical wires 22 are sewn using the sewing machine, considered is a case where a needle thread and a bobbin thread in the sewing machine are prepared separately from the electrical wires 22 or a case where the electrical wires 22 are used as one of the needle thread and the bobbin thread in the sewing machine.

However, the method of fixing the electrical wires 22 to the sheet material 30 is not limited to the sewing. For example, the electrical wires 22 may be fixed to the sheet material 30 by welding as is a case for a wire harness 120 illustrated in FIG. 7. Considered is that the insulating covering in the electrical wires 22 is welded to the sheet material 30. Applicable in this case is the sheet material 30 enabling the welding of the electrical wires 22. Applicable as the welding method is ultrasonic welding, laser welding, or thermal welding, for example.

The wire harness 20 is fixed to the interior member 10 while the sheet material 30 is spread. A fixing method described hereinafter, for example, is considered as a method of fixing the wire harness 20.

A fixing method using a pressure sensitive adhesive double sided tape 40 is described firstly. In the example illustrated in FIG. 3, the sheet material 30 is fixed to the interior member 10 by the pressure sensitive adhesive double sided tape 40 intervening between the sheet material 30 and the interior member 10. In this case, the wire harness 20 may be fixed to the interior member 10 as follows, for example. That is to say, the pressure sensitive adhesive double sided tape 40 is previously attached to the wire harness 20. The wire harness 20 to which the pressure sensitive adhesive double sided tape 40 is attached is transported to a vehicle assembly plant. A release liner of the pressure sensitive adhesive double sided tape 40 is peeled in the vehicle assembly plant. Subsequently, a part of the wire harness 20 having the pressure sensitive adhesive double sided tape 40 is attached to the interior member 10. In this manner, the pressure sensitive adhesive double sided tape 40 is previously attached to the wire harness 20, thus the number of manufacturing processes in the vehicle assembly plant can be reduced.

A fixing method using sandwiching is described next. In the example illustrated in FIG. 4, the sheet material 30 is sandwiched between the plate-like member 12 and the attaching member 16 together with the electrical wires 22, thus the wire harness 20 is fixed to the interior member 10. In this case, the sheet material 30 having cushioning characteristics is applicable. Large force on the electrical wires 22 can be thereby reduced.

Furthermore in this case, a groove 15 in which the electrical wires 22 are housed may be formed on at least one of the plate-like member 12 and the attaching member 16 in a portion where the electrical wires 22 are sandwiched. In the example illustrated in FIG. 4, the groove 15 is formed on the plate-like member 12. The groove 15 is formed by pressing the plate-like member 12, for example. The pressing may be performed along with a pressing for bending and deforming the flat plate-like member 12 into a shape corresponding to the ceiling part 82. Large force applied on the electrical wires 22 can also be reduced by forming the groove 15. A distance from a bottom of the groove 15 to a surface of the plate-like member 12 or the attaching member 16 facing the bottom is set to a size in which the sheet material 30 and the electrical wires 22 can be sandwiched between the plate-like member 12 and the attaching member 16. For example, the distance from the bottom of the groove 15 to the surface of the plate-like member 12 or the attaching member 16 facing the bottom is set smaller than a sum of a thickness dimension of the sheet material 30 and a diameter of the electrical wires 22.

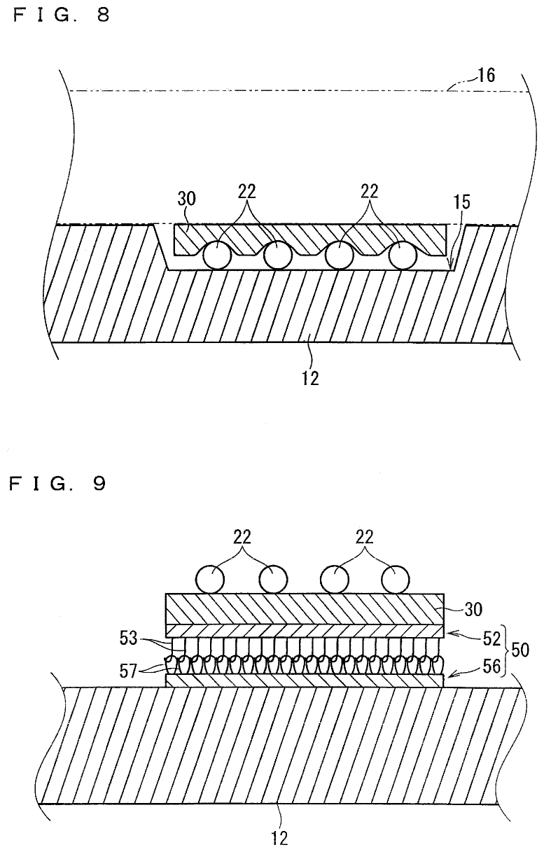

In the example illustrated in FIG. 4, the main surface of the sheet material 30 where the electrical wires 22 are not disposed faces the plate-like member 12, however, this configuration is not necessary. In the example illustrated in FIG. 8, the main surface of the sheet material 30 where the electrical wires 22 are not disposed may face the attaching member 16.

A fixing method using a touch fastener 50 is described next. In the example illustrated in FIG. 9, the sheet material 30 is fixed to the interior member 10 by the touch fastener 50 intervening between the sheet material 30 and the interior member 10. In this case, the touch fastener 50 is previously attached to the wire harness 20 in the manner similar to the case of using the pressure sensitive adhesive double sided tape 40, thus the number of manufacturing processes in the vehicle assembly plant can be reduced.

Considered in a case where the touch fastener 50 is used is that a male member 52 having hooks 53 is provided on one of the sheet material 30 and the interior member 10 and a female member 56 having loops into which the hooks 53 is hooked is provided on the other one of the sheet material 30 and the interior member 10. In the example illustrated in FIG. 9, the male member 52 is provided on the sheet material 30, and the female member 56 is provided on the interior member 10, however, a reverse configuration is also applicable.

Herein, known as the female member 56 is a dedicated member in which loops 57 is napped so that the male member 52 is easily fastened. Known is that even a member in which the loops 57 are not specially napped can be used as the female member 56 as long as the member has characteristics that the hooks 53 can be hooked, such as a non-woven cloth and a woven cloth.

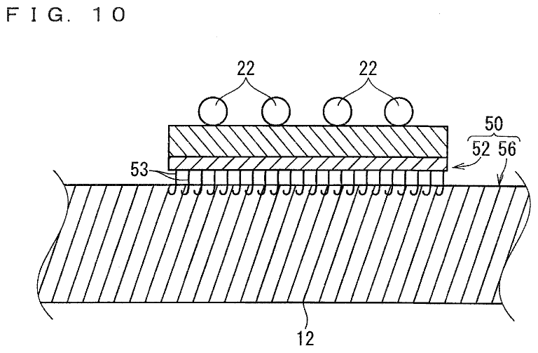

Herein, there may be a case where a non-woven cloth or a woven cloth is used as a reinforcement layer or a surface skin layer in the plate-like member 12 as described above. When the surface layer of the rear surface in the plate-like member 12 is formed of a material having the characteristics that the hooks 53 can be hooked, the surface layer of the rear surface in the plate-like member 12 can be used as the female member 56 in the touch fastener 50. That is to say, as illustrated in FIG. 10, the male member 52 is provided on the sheet material 30 in the wire harness 20 so that the hooks 53 protrude toward the plate-like member 12, thus the male member 52 can be directly fastened to the plate-like member 12 without particularly providing the dedicated female member 56 on the plate-like member 12. In this case, the male member 52 can be fastened to any position in the plate-like member 12.

When the male member 52 is provided on the plate-like member 12 and the female member 56 is provided on the sheet material 30, considered is a case where a dedicated female member 56 in which the loops 57 are napped is additionally attached to the sheet material 30. Furthermore, also considered is that the sheet material 30 is formed of a material having the characteristics that the hooks 53 are hooked, thus the sheet material 30 itself is used as the female member 56.

A region where the pressure sensitive adhesive double sided tape 40 is provided may be the entire region in the sheet material 30, or part of region therein may also be applicable. When the region where the pressure sensitive adhesive double sided tape 40 is provided is only the part of the region in the sheet material 30, considered as the region is, for example, a region including an end of a portion covering the electrical wires 22 (refer to a region A in FIG. 2), a region including a portion covering the branched part or bent part of the electrical wires 22 (refer to a region B in FIG. 2), and a region including the rim of the sheet material 30 (refer to a region C in FIG. 3). The same applies to a region where the touch fastener 50 is provided.

When the pressure sensitive adhesive double sided tape 40 is provided, as illustrated in FIG. 3, the pressure sensitive adhesive double sided tape 40 may be provided on a surface opposite to the main surface where the electrical wires 22 are disposed or the main surface where the electrical wires 22 are disposed. When the pressure sensitive adhesive double sided tape 40 is provided on the main surface where the electrical wires 22 are disposed, it is preferable that a flange part where the electrical wires 22 are not provided is formed on a lateral side of the part of the sheet material 30 where the electrical wires 22 are disposed to increase an adhesion area of the pressure sensitive adhesive double sided tape 40. The same applies to the case where the touch fastener 50 is provided.

According to the above embodiment, an area of contact between the wire harness 20 and the interior member 10 can be increased, thus even when a force for the fixation per unit area is small, the wire harness 20 can be fixed to the interior member 10. Thus, the wire harness 20 can be fixed to the interior member 10 also by previously providing a fixing member on the wire harness 20. Accordingly, the wire harness 20 can be simply fixed, in assembling the vehicle, even to a mounting object which is not suitable for having a clamp hole to fix a clamp.

The wire harness 20 can be simply fixed by using the pressure sensitive adhesive double sided tape 40.

The wire harness 20 can be simply fixed by sandwiching the sheet material 30 and the electrical wires 22 between the plate-like member 12 and the attaching member 16. At this time, the groove 15 in which the electrical wires 22 are housed is formed on at least one of the plate-like member 12 and the attaching member 16 in the portion where the electrical wires 22 are sandwiched, thus it can be suppressed that the electrical wires 22 are sandwiched with the large force.

The wire harness 20 can be simply fixed also by using the touch fastener 50. At this time, the wire harness 20 can be fixed to the plate-like member 12 by using the male member 52 provided on the wire harness 20. In this case, when the surface layer in the plate-like member 12 is formed of the material having the characteristics that the hooks 53 can be hooked, the plate-like member 12 itself can be used as the female member 56, thus the male member 52 can be fastened to any position in the plate-like member 12.

The sheet material 30 extends along the path of the electrical wires 22, thus the area of the sheet material 30 can be reduced. Increase in weight caused by providing the sheet material 30 can be thereby reduced.

### MODIFICATION EXAMPLE

In the example illustrated in FIG. 2, a flow path of the duct is set to cross the electrical wires 22, however, this configuration is not necessary. There may be a case where the flow path of the duct is parallel to the electrical wires 22. In this case, the duct preferably crosses the electrical wires 22 in a width direction (a direction orthogonal to an extension direction of the flow path). At this time, a width dimension of the duct is preferably set larger than a distance between the two electrical wires 22 located outermost in the plurality of flatly formed electrical wires 22. Accordingly, all of the electrical wires 22 parallel to the duct can be sandwiched between the duct and the plate-like member 12.

Each configuration described in the embodiment and each modification example can be appropriately combined as long as they are not contradictory. For example, when one wire harness 20 is fixed to the interior member 10, applicable are the three fixing structures described above of the fixing structure using the pressure sensitive adhesive double sided tape 40, the fixing structure using the touch fastener 50, and the fixing structure using the sandwiching by the plate-like member 12 and the attaching member 16. Further applicable is that the fixing structure using the pressure sensitive adhesive double sided tape 40 or the touch fastener 50 and the fixing structure using the sandwiching by the plate-like member 12 and the attaching member 16 are simultaneously adopted to the fixing structure in the same position in the wire harness 20.

Although the present invention is described in detail, the foregoing description is in all aspects illustrative and does not restrict the invention. It is therefore understood that numerous modifications and variations can be devised without departing from the scope of the invention.

### EXPLANATION OF REFERENCE SIGNS

1 wire harness fixing structure

10 interior member

12 plate-like member

15 groove

16 attaching member

20 wire harness

22 electrical wire

24 connector

30 sheet material

38 thread

40 pressure sensitive adhesive double sided tape

50 touch fastener

52 male member

53 hook

56 female member

57 loop

80 vehicle body

82 ceiling part

1. A wire harness fixing structure, comprising:
an interior member including a plate-like member and interiorly mounted on a vehicle; and
a wire harness including an electrical wire disposed along the plate-like member and a sheet material having cushioning characteristics and to which the electrical wire is fixed by sewing or welding, having a portion of the electrical wire disposed to be bent on the sheet material, wherein
the wire harness is fixed to the interior member while the sheet material is spread.

2. The wire harness fixing structure according to claim 1, further comprising
a pressure sensitive adhesive double sided tape intervening between the sheet material and the interior member.

3. The wire harness fixing structure according to claim 1, further comprising
a touch fastener intervening between the sheet material and the interior member.

4. The wire harness fixing structure according to claim 3, wherein
the touch fastener includes a male member fixed to the sheet material and having hooks protruding toward the plate-like member, and
a surface layer in the plate-like member is formed of a material having characteristics that the hooks can be hooked.

5. The wire harness fixing structure according to claim 1, wherein
the interior member includes an attaching member incorporated into the plate-like member and crossing the electrical wire, and
the sheet material is sandwiched between the plate-like member and the attaching member together with the electrical wire, thus the wire harness is fixed to the interior member.

6. The wire harness fixing structure according to claim 5, wherein
a groove in which the electrical wire is housed is formed on at least one of the plate-like member and the attaching member in a portion where the electrical wire is sandwiched.

7. The wire harness fixing structure according to claim 1, wherein
the sheet material extends along a path of the electrical wire.

8. The wire harness fixing structure according to claim 1, wherein
the sheet material extends to be bent along a bent path of the electrical wire in the portion of the electrical wire disposed to be bent on the sheet material.

9. The wire harness fixing structure according to claim 1, wherein
the sheet material is formed of non-woven cloth as a material.

10. A wire harness fixing structure, comprising:
an interior member including a plate-like member and interiorly mounted on a vehicle; and
a wire harness including an electrical wire disposed along the plate-like member and a sheet material to which the electrical wire is fixed by welding an insulating covering of the electrical wire, having a portion of the electrical wire disposed to be bent on the sheet material, wherein
the wire harness is fixed to the interior member while the sheet material is spread.
